(19) United States
(12) Patent Application Publication
(10) Pub. No.: US 2016/0195955 A1
(43) Pub. Date: Jul. 7, 2016

(54) Combined Sensor System

(71) Applicant: Microsoft Technology Licensing, LLC, Redmond, WA (US)

(72) Inventors: Carl E. Picciotto, Clyde Hill, WA (US); John Jacob Nelson, Redmond, WA (US); Brian R. Cox, Seattle, WA (US)

(21) Appl. No.: 14/591,704

(22) Filed: Jan. 7, 2015

(51) Int. Cl. G06F 3/044; G06F 3/041

(52) U.S. Cl. CPC G06F 3/044; G06F 3/0414; G06F 2203/0382; G06F 2203/04105; G06F 2203/04106

(57) ABSTRACT

Combined sensor systems are described. In one or more implementations, an input device includes a sensor substrate having conductors and a flexible contact layer spaced apart from the sensor substrate. The input device includes a combined sensor system having a capacitive sensor assembly to detect a location of an object proximate to a capacitive sensor and a pressure sensitive sensor assembly configured to detect an amount of pressure applied against a pressure sensitive sensor. The pressure sensitive sensors are interspersed with capacitive sensors in a geometric pattern that enables isolation of signals for pressure detection and capacitive sensing. The combined sensor system includes support structures proximate to the pressure sensitive sensors for pre-load control over force sensitive resistors of the flexible contact layer. The combined sensor system also includes adhesive disposed in association with positions of the capacitive sensors to stabilize capacitive sensing under the influence of pressure.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example operating environment that is operable to employ the combined sensor system techniques described herein in accordance with one or more implementations.

FIG. 2 depicts an example implementation of an input device of FIG. 1 in greater detail.

FIG. 3 depicts a cross section of the input device of FIG. 1 showing an example stack of layers in accordance with one or more implementations.

FIG. 4 depicts a cross section of the sensor layer of FIG. 3 showing details of the combined sensor system details in accordance with one or more implementations.

FIG. 5 depicts a representative arrangement of sensors for a combined sensor system in a geometric pattern in accordance with one or more implementations.

FIG. 6 depicts an example exploded view of a stack of layers for combined sensor system in which pressure sensitive sensors of a pressure sensitive sensor assembly are interspersed with capacitive sensors of a capacitive sensor assembly in accordance with one or more implementations.

FIG. 7 depicts an example layout showing details of components of a sensor substrate (e.g., PCB) for a combined sensor system in accordance with one or more implementations

FIG. 8 depicts an example procedure in which a capacitive sensor assembly and pressure sensitive sensor assembly are arranged to produce a combined sensor system in accordance with one or more embodiments.

FIG. 9 illustrates an example system that includes an example computing device that is representative of one or more computing systems and/or devices that may implement the various techniques described herein.

### DETAILED DESCRIPTION

Overview

Various types of input devices may be employed with computing devices to enable user inputs for interaction with the device such as keyboards, trackpads, touchpads, and pointing devices (e.g., a mouse), to name a few examples. Conventional input devices, such as a mouse or keyboard, have buttons and/or keys arranged at fixed locations that are used to initiate input signals in response to pressure when depressed. Other devices like touch digitizers and pads utilize capacitive sensing to recognize presence and location information for user inputs and touch gestures. Traditionally, individual input devices rely upon a single sensing technology due to interference caused between technologies, difficulty of arranging multiple kinds of sensors, and considerations of device size and cost.

Combined sensor systems are described herein. In one or more implementations, an input device includes a combined sensor system having a capacitive sensor assembly including a plurality of capacitive sensors arranged in an array that is configured to detect a location of an object that is proximate to a respective capacitive sensor of the capacitive sensor assembly and a pressure sensitive sensor assembly including a plurality of pressure sensitive sensors that are configured to detect an amount of pressure applied (e.g., deflection resulting from a force) by the object against a respective pressure sensitive sensor of the pressure sensitive sensor assembly. The plurality of pressure sensitive sensors are interspersed with the capacitive sensors in a geometric pattern that enables isolation of signals for the capacitive sensor assembly and the pressure sensitive sensor assembly. The combined sensor system includes support structures proximate to the pressure sensitive sensors for pre-load control over force sensitive resistors of the flexible contact layer. The combined sensor system also includes adhesive filled into portions associated with positions of the capacitive sensors in the arrangement to stabilize capacitive sensing under the influence of pressure.

Combined sensor systems as described in this document enable input devices and controls that are configured to simultaneously determine presence and pressure of multiple finger touches, which increase accuracy and enables enhanced gestures and interaction scenarios. Additionally, because the described arrangements isolate pressure sensing control lines from capacitive sensing control lines, interference is minimized resulting in more efficient measurement with greater sensitivity and lower error rates. Further, support structures for setting pre-load along with the adhesive aligned with capacitive sensors enable precise control over force sensitive resistor pre-loads and capacitive sensor operation in the presence of applied pressure, which further improves the accuracy and performance of the combined sensor system. Additionally, combined sensor systems described herein may provide more cost effective and smaller (e.g., thinner) devices due to the combined use of layers for multiple purposes and co-location of different sensors in a common array.

In the following discussion, an example environment is first described that may employ the techniques described herein. Examples of a stack of layers that are usable in the example environment (i.e., the input device) are then described which may be utilized in the example environment as well as other environments. Consequently, use of the example layers is not limited to the example environment and the example environment is not limited to use of the example layers.

Operating Environment

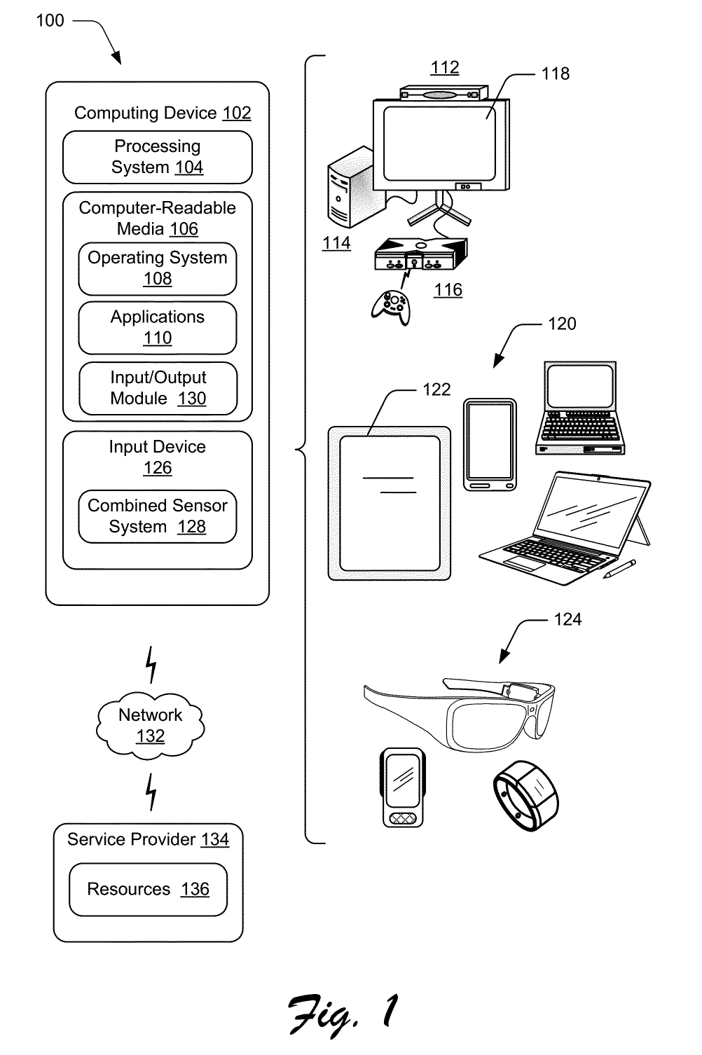

FIG. 1 illustrates an operating environment in accordance with one or more implementations, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and one or more applications 110 that reside on the computer-readable media and which are executable by the processing system. The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

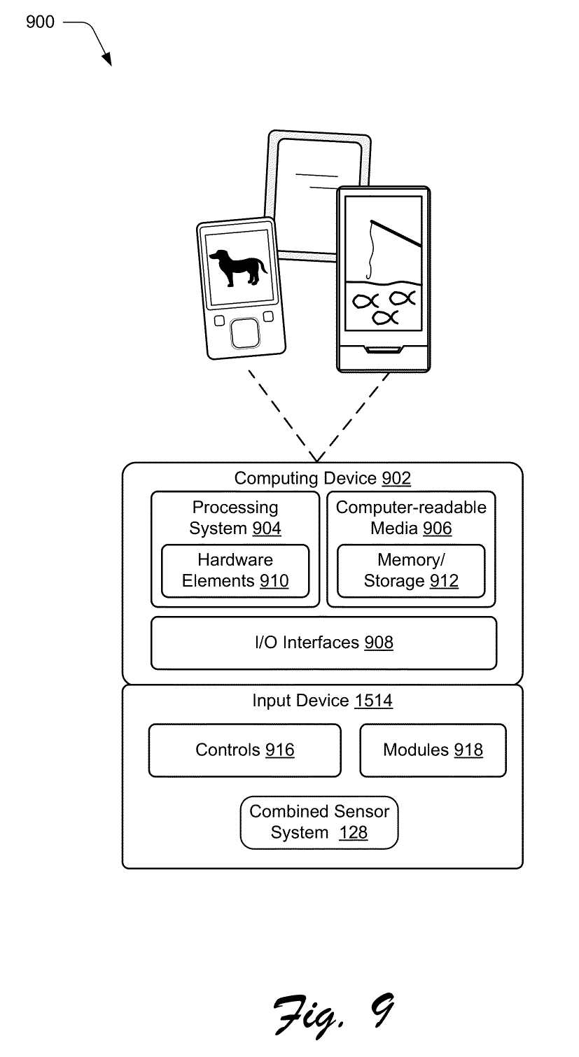

The computing device 102 can be embodied as any suitable computing system and/or device such as, by way of example and not limitation, a gaming system, a desktop computer, a portable computer, a tablet or slate computer, a handheld computer such as a personal digital assistant (PDA), a cell phone, a set-top box, a wearable device (e.g., watch, band, glasses, etc.), and the like. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, a smart band or watch, and a pod device such as clip-on fitness device, media player, or tracker. Other examples of wearable devices 124 include but are not limited to a ring, an article of clothing, a glove, and a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 9.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 9.

The computing device 102 may include or make use of an input device 126. For example, the computing device 102 may be communicatively coupled to one or more input device 126 via any suitable wired or wireless connection. Input devices include devices integrated with the computing device 102, such as an integrated keyboard, touchpad, track pad, pointer device, a bezel or other touch operable component of a tablet or wearable device, a touch capable display, and so forth. Input devices also include external devices and removably connectable devices such as a mouse, wireless keyboard, removable keyboard/cover combination, a wearable device used to control the computing device through a wireless connection, an external touchpad, and so forth. Other non-conventional configurations of an input device are also contemplated, such as a game controller, configuration to mimic a musical instrument, and so forth. Thus, the input device 126 and controls incorporated by the input device (e.g., buttons, keys, touch regions, toggles, etc.) may assume a variety of different configurations to support a variety of different functionality.

In accordance with one or more implementations described herein, an input device 126 may include a combined sensor system 128. As introduced above, the combined sensor system 128 is designed to simultaneously determine presence and pressure of multiple finger touches. By so doing, accuracy is increased and enhanced gestures and interaction scenarios using capabilities of the combined sensor system 128 become possible. As described in detail in relation to the following figures and examples, the combined sensor system 128 is configured to include a plurality of pressure sensitive sensors that are interspersed with capacitive sensors in a geometric pattern that enables isolation of signals for a capacitive sensor assembly and a pressure sensitive sensor. The combined sensor system 128 may be included in a stack of a plurality of layers that form an input device. The plurality of layers may include a combination of flexible and/or rigid materials and components that make-up structure for the input device and form the pressure sensitive sensors and capacitive sensors contained within the layers. The combined sensor system 128 includes support structures proximate to the pressure sensitive sensors for pre-load control over force sensitive resistors of a flexible contact layer. The combined sensor system 128 also includes adhesive associated with positions of the capacitive sensors in the arrangement to stabilize capacitive sensing under the influence of applied pressure. Details regarding these and other aspects of a combined sensor system 128 can be found in the following discussion.

The computing device 102 is additionally illustrated as including an input/output module 130. The input/output module 108 is representative of functionality relating to processing of inputs and rendering outputs of the computing device 102. A variety of different inputs may be processed by the input/output module 130, such as inputs relating to operation of controls of the input device 126, keys of a virtual keyboard, identification of gestures through touchscreen functionality, and so forth. Responsive to the inputs, the input/output module 130 causes corresponding operations to be performed. Thus, the input/output module 130 may support a variety of different input techniques by recognizing and leveraging a division between types of inputs including key presses, gestures, control interaction, and so on.

The environment 100 further depicts that the computing device 102 may be communicatively coupled via a network 132 to a service provider 134, which enables the computing device 102 to access and interact with various resources 136 made available by the service provider 134. The resources 136 can include any suitable combination of content and/or services typically made available over a network by one or more service providers. For instance, content can include various combinations of text, video, ads, audio, multi-media streams, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of combined sensor systems.

Combined Sensor System Details

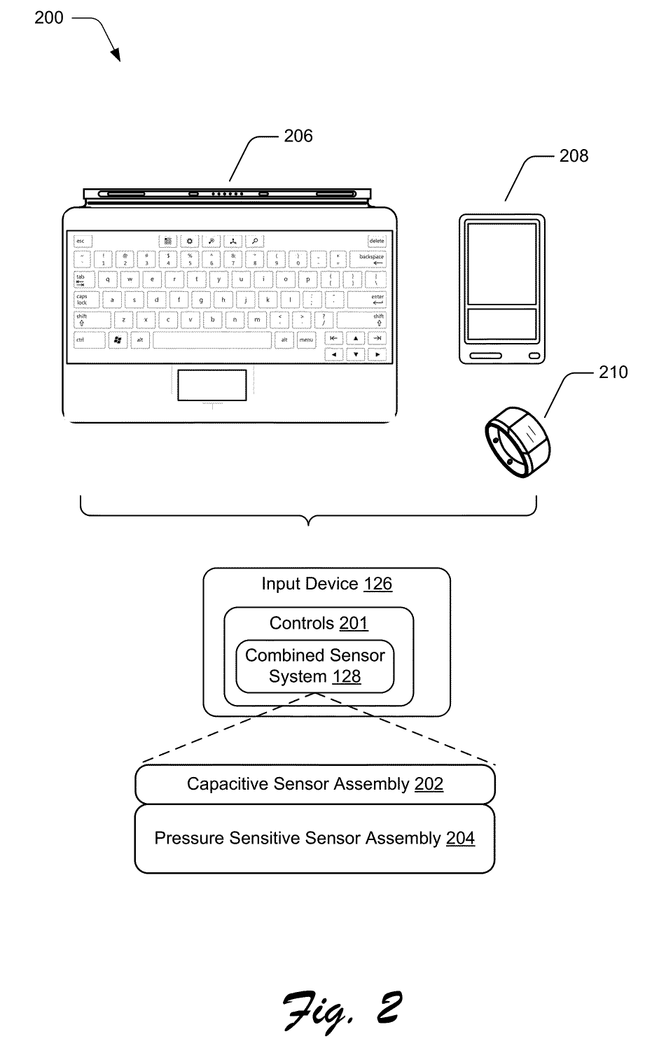

FIG. 2 depicts generally at 200 an example implementation of an input device 126 of FIG. 1 in greater detail. In the illustrated example, the input device 126 is represented as having various controls 201 that may be implemented by way of a combined sensor system 128 as described in this document. Various types of controls 201 are contemplated, such as by way of example and not limitation an arrangement of keys, buttons, touchpads, trackpads, a touch sensitive bezel, a touchscreen, a region of a wearable device such as a display, band, patch, or surface, or other input functionality. As represented in FIG. 2, the combined sensor system 128 incorporates a capacitive sensor assembly 202 and a pressure sensitive sensor assembly 204 that are configured and operate as described above and below. For instance, a capacitive sensor assembly and a pressure sensitive sensor assembly may be interspersed together in a stack of layers, and also may include support structures for pre-load control and adhesive aligned with capacitive sensors for capacitive sensor stabilization.

The combined sensor system 128 may be utilized for controls 201 associated with various input devices 126. Illustrative examples of input devices 126 in FIG. 2 include a keyboard 206, a mobile device 208, and a watch 210. The keyboard 206 may be a wireless keyboard or a removably connectable device. The combined sensor system 128 may be employed for one or more of a QWERTY arrangement of keys, a trackpad, and/or other input functionality of the keyboard 206. With respect to the mobile device 208, a combined sensor system 128 may be integrated with a bezel or other outer surface of the device, a display screen, or an integrated touchpad. A combined sensor system 128 may also be included with a display, band, bezel or other functionality of the watch 210. A variety of other examples are also contemplated.

The capacitive sensor assembly 202 is configured to detect proximity of an object, such as a finger of a user's hand, a stylus, or other object. This detection may be leveraged to support a wide variety of different functionality, such as gesture detection, user presence indications, control over sleep and wake states of an input device and computing device, cursor control, input locations, and so forth. The capacitive sensor assembly 202 may be configured in a variety of ways to perform object detection. Generally, the capacitive sensor assembly 202 includes a plurality of capacitive sensors configured to detect presence and locations of objects against or near to the surface of a device by measuring changes in capacitance relative to a reference (e.g., air) due to positioning of the objects. The sensors operate by measuring either or both of mutual-capacitance and self-capacitance. Capacitive sensors may work even before a finger or object touches the surface of the device. In one or more implementations, the capacitive sensor assembly 202 may be utilized to conserve power as well as increase responsiveness of devices, e.g., by detecting presence and/or location before contact with pressure sensitive sensors and selectively waking up systems based on presence indications. As noted in the discussion below, capacitive sensor assembly 202 may be formed by disposing traces of conductive material in stack of layers corresponding to a printed circuit board (PCB) for the input device.

The pressure sensitive assembly 204 includes a plurality of pressure sensitive sensors configured to detect an amount of deflection and/or corresponding pressure applied by the object due to force against a respective pressure sensitive sensor of the pressure sensitive sensor assembly. In an example, the pressure sensitive sensors are configured to utilize force sensing resistance technology to determine locations at which pressure is applied and the magnitude of pressure. As described below, the pressure sensitive sensors may be configured as force sensitive resistors that utilize first and second inter-digitized trace fingers of conductive material. Resistance changes measured between the first and second inter-digitized trace fingers when in contact with force sensitive ink disposed on a flexible contact layer can be correlated to deflection and pressure applied to corresponding regions of the flexible contact layer to enable pressure detection.

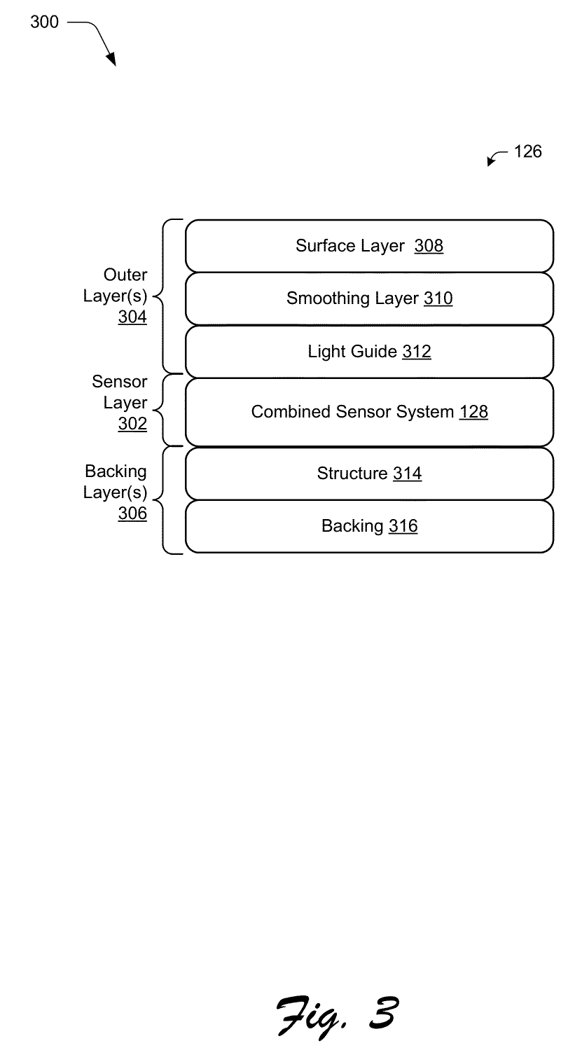

FIG. 3 depicts generally at 300 a cross section of the input device of FIG. 1 showing an example layer stack in accordance with one or more implementations. In this example, as sensor layer 302 for an input device 126 is depicted as being disposed between an outer layer(s) 304 and a backing layer(s) 306. In accordance with techniques described herein, the sensor layer 302 includes a combined sensor system 128, details of which are discussed throughout this document. The outer layer 304 is configured to supply an outer surface as well as structure for the device. The outer layer 304 may be formed in a variety of ways, such as using metal, fabric (e.g., silk or polyurethane), and/or plastic material, disposing adhesive material and films to secure layers, forming indications of various controls on the surface, embedding controls in the layers, and so on.

Representative sub-layers in an example implementation are depicted as being included within the outer layer 304 including a surface layer 308, a smoothing layer 310, and a light guide layer 312. Other arrangements are also contemplated. In the example, the surface layer 308 represents the outer surface with which a user may touch and interact. In an implementation, the surface layer 308 is made of flexible fabric (e.g., silk or polyurethane), although plastics and other rigid materials are also contemplated. The smoothing layer 310 may be configured to support a variety of different functionality. For instance, the smoothing layer 310 may be configured as a thin plastic sheet (e.g., PET, polycarbonate), designed to support and prevent wrinkling of a surface layer 308. The smoothing layer 310 may also be configured to including masking functionality to reduce and even eliminate unwanted light transmission, e.g., “bleeding” of light through the smoothing layer and/or through the surface layer 308. The smoothing layer 310 also provides a continuous surface under the surface layer 308 that acts to conceal discontinuities or transitions between the inner layers. The smoothing layer 310 can also provide a force-spreading function to spread forces across multiple sensors for greater sensitivity and resolution.

A light guide 312 is also illustrated, which may be provided as part of a backlight mechanism to support backlighting of indications (e.g., legends) of controls and/or input on the surface. This may include illumination of keys of a keyboard, buttons, game controls, gesture indications, and so on. The light guide 312 may be formed in a variety of ways, such as from thick sheet of a plastic, e.g., a clear polycarbonate, PET, or other polyester film material with etched texturing.

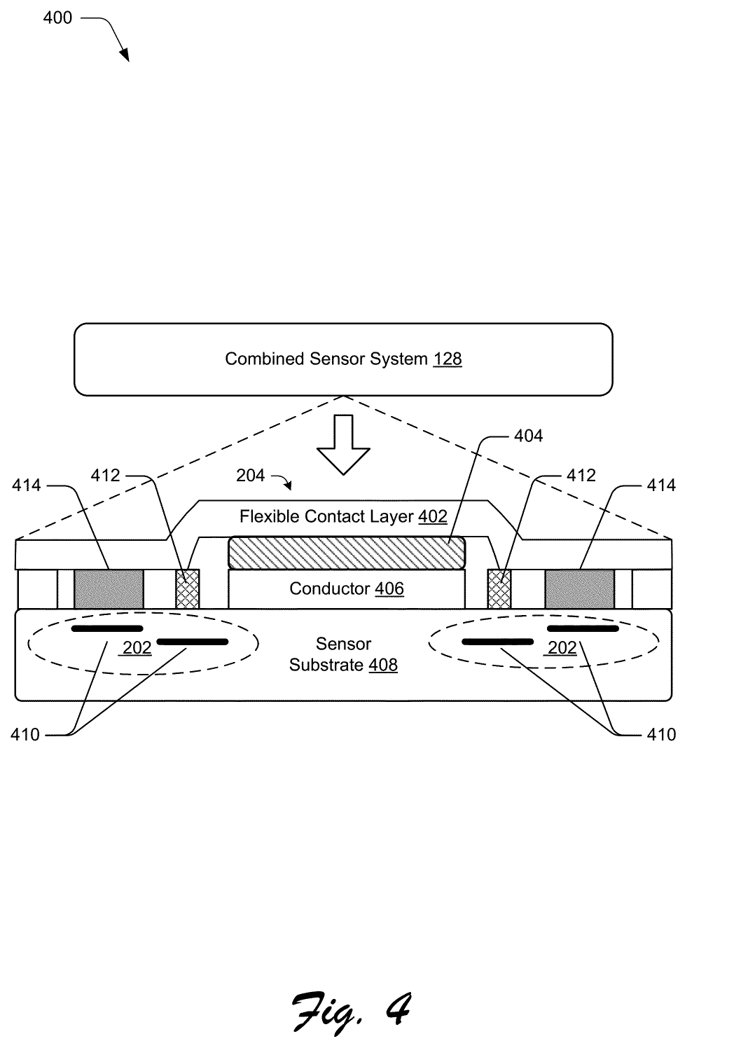

As depicted, the sensor layer 302 having the combined sensor system 128 resides below the outer layer 302. The combined sensor system 128 is configured detect initiation of input based on interaction that occurs via contact with and/or proximity of objects to the surface layer. The detected input is then communicated to the computing device 102 via a suitable wired or wireless connection to initiate operations of the computing device 102. Details of an example implementation of a combined sensor system 128 are discussed in the discussion of FIGS. 4-7 that follows.

Additionally, the backing layer 306 provides a rear surface as well as structure for the input device 104. The backing layer 306, for instance, may provide structure for the device that is complimentary to the outer layer 304 and may be formed from metal, fabric (e.g., polyurethane), and/or plastic material comparable to the outer layer 304. Representative sub-layers for structure 314 and backing 316 are depicted as being included within the backing layer 306. The structure 314 may be configured in a variety of ways, such as a trace board and backer that are configured to provide rigidity to the input device, e.g., resistance to bending and flexing. The backing 316 provides a rear surface for the device. By way of example, the backing may be formed from a fabric or material similar to the surface layer 308.

Although examples of layers have been described, it should be readily apparent that a variety of other implementations are also contemplated, including removal of one or more of the layers, addition of other layers (e.g., a dedicated force concentrator layer, mechanical switch layer), and so forth. Thus, layers used to form suitable input devices and controls that make use of a combined sensor system 128 are not limited to the layers depicted and discussed with respect to the illustrative examples herein.

FIG. 4 depicts generally at 400 a cross section of the sensor layer of FIG. 3 showing details the combined sensor system details in accordance with one or more implementations. In the example implementation of FIG. 4, the combined sensor system includes a flexible contact layer 402 (e.g., Mylar) for implementation of a pressure sensitive sensor (e.g., a force sensitive resistor) of a pressure sensitive sensor assembly 204. The flexible contact layer 402 is configured to flex to initiate contact and thus an input. The flexible contact layer 402 in this example includes a force sensitive ink 404 disposed on a surface of the flexible contact layer 402. The force sensitive ink 404 is configured such that an amount of resistance of the ink varies directly in relation to an amount of pressure applied. The force sensitive ink 404, for instance, may be configured with a relatively rough surface that is compressed against another surface of a conductor 406 upon application of pressure against the flexible contact layer 402. The greater the amount of pressure, the more the force sensitive ink 404 is compressed, thereby increasing conductivity and decreasing resistance of the force sensitive ink 404. In one approach, pressure is detected by measuring resistance across a gap between inter-digitized trace fingers of conductive material formed within the conductor 406.

FIG. 4 further depicts a sensor substrate 408 that is configured to form a pressure sensitive sensor assembly 204 and the capacitive sensor assembly 202. The sensor substrate 408 may be configured in a variety of ways, such as a being a printed circuit board (PCB) having conductors 406 (e.g., FSR electrodes) and other elements disposed thereon. A variety of different types of conductors 406 may be disposed on the sensor substrate 408, such as conductors formed from a variety of conductive materials (e.g., silver, copper) and disposed in a variety of different configurations The conductors 406 and other elements may be created in the sensor substrate 408 using various techniques such as chemical etching, masking, lamination, electroplating, silk screen printing, photoengraving, PCB milling, or other techniques typically involved in PCB manufacture.

As noted, a capacitive sensor assembly 202 is formed in the sensor substrate 408 as illustrated by representative traces 410 for capacitive sensing. The traces 410 are arranged to produce a plurality of capacitive sensors. Touch and presence is detected based on changes in capacitance across gaps between the traces 410 for capacitive sensing.

FIG. 4 additionally illustrates supporting structures 412 that are fabricated proximate to pressure sensitive sensors of the pressure sensitive sensor array 204 and adhesive 414 that is disposed in association with positions of capacitive sensors in the PCB arrangement. As mentioned, one issue associated with producing a combined sensor system is preserving the stability of capacitive sensing when pressure is applied to the sensor stack. In particular, gaps in the layer of conductors formed to expose the traces 410 to upper layers create pockets of air that may be displaced (e.g., “squeezed out”) under the influence of applied pressure. If left uncorrected, the displacement of air from these pockets creates instability that is disruptive to capacitive sensing, distorts sensed inputs, and adversely effects performance of the input device.

Selectively placing the adhesive 414 in alignment with positions of capacitive sensors, though, reduces or eliminates the amount of displaced air and therefore stabilizes performance of the capacitive sensors even when pressure is being applied. Generally, the adhesive 414 is placed in regions that are in-line in the stack vertically with traces 410. For instance, FIG. 4 depicts adhesive 414 as being located above corresponding traces 410 in the example stack. The adhesive 414 may be configured to align with interior, open portions of a footprint of the traces 410. Thus, the adhesive 414 can be placed directly over the capacitive sensors. In addition or alternatively, adhesive can be placed in portions corresponding to gaps between sensors in the array. In general, the adhesive can be placed in alignment with capacitive sensors in various gasp or open regions that do not cause interference with the traces 410, supporting structures 412 or other elements in the combined sensor system. A variety of different pressure sensitive adhesives or other kinds of adhesive suitable to fill the gaps are contemplated.

The supporting structures 412 fabricated proximate to pressure sensitive sensors are provided to control pre-loading of the flexible contact layer 402 and force sensitive ink 404 with the underlying conductor 406. Pre-load refers to the default level of contact between the force sensitive ink 404 and the underlying conductor 406 that exists in the absence of applied contact. A amount of pre-load to place the force sensitive ink 404 in constant contact with the conductor 406 is useful in order to resolve light touches (e.g., applied pressure at low-levels) and provide a responsive sensor system. Too much pre-load causes pre-saturation of the sensors which reduces the range of operation and sensitivity of the pressure sensitive sensors. Pre-load may be established by design of the stack above the flexible contact layer 402 and the adhesive and other securing mechanisms used to join the layers. The amount of pre-load is also effected by the application of adhesive 414, which tends to pull down the flexible contact layer 402 and other layers. Accordingly, the supporting structures 412 are designed to set the amount of pre-load at a particular level to support detection of applied pressure at low-levels and counteract the tendency of adhesive 414 and other factors that may otherwise adversely affect pre-load.

The supporting structures 412 may be formed in various ways. In one approach, the supporting structures 412 are fabricated using conductive material (e.g., copper, silver, etc.) along with the conductors 406 using the same PCB process or processes. In one example, the supporting structures 412 are configured as conductive bars. The conductive bars may match the material of the conductors 406 and may be formed to have the same height as the conductors 406. Thus, when copper is employed for conductors 406, the supporting structures 412 may be configured as copper bars that have substantially the same height as the conductors 406. When, the supporting structures 412 and conductors 406 are coordinated in this manner, the pre-load corresponds to the thickness of the force sensitive ink 404 that is included on the flexible contact layer 402. This approach results in a relatively light pre-load that provides responsiveness for resolution of light touches and detection over a wide range of pressure levels. Naturally, supporting structures 412 may be fabricated using different heights and materials than the conductors 406 in some cases to provide different pre-load levels that are appropriate for the particular device and/or end user scenarios. Thus, characteristics of the supporting structures 412 may be selectively adapted to achieve a corresponding level of pre-load.

In order to achieve the pre-load as well as control over capacitive stabilization, the adhesive 414 may be configured to have a height that is slightly less than the height of the supporting structures 412 and conductors 406. By way of example and not limitation, the supporting structures 412 and conductors 406 may have a height of about 25 to 35 microns in which case adhesive 414 may be placed with a height of about 15 to 25 microns. By making the adhesive height slightly lower, the adhesive 414 operates to pull down the upper layers (e.g., flexible contact layer 402) to create contact with the conductors 406 and achieve the pre-loading.

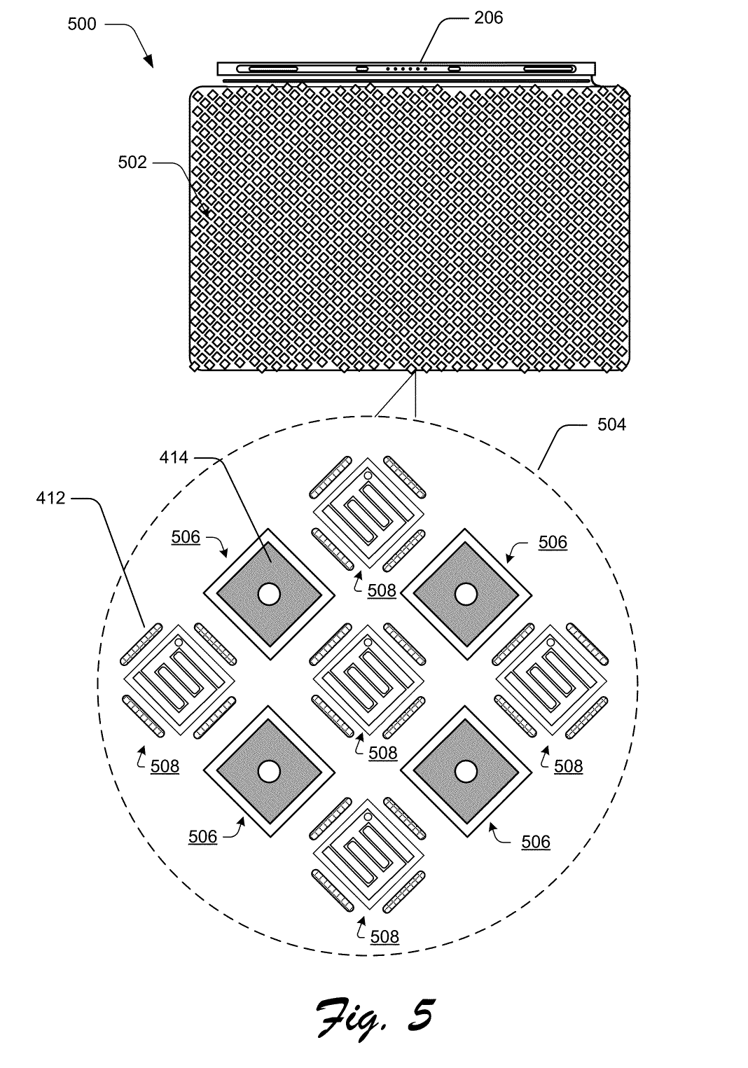

FIG. 5 depicts a representative arrangement 500 of sensors for a combined sensor system in a geometric pattern in accordance with one or more implementations. In the arrangement 500, the input device is depicted in the form of a keyboard 206, which may be formed using a stack of layers as noted herein. At least a portion of the keyboard may include an array 502 of sensors for a combined sensor system 128 that are arranged in a geometric pattern. The array 502 may be configured in various ways. In the depicted example, a diamond pattern is employed, but other patterns are also contemplated including but not limited to hexagonal, octagonal, and circular grid patterns. Further, the array 502 as depicted provides sensing coverage for substantially the entire surface of the keyboard 206. Alternatively, a keyboard or other device may be configured to have one or more individual portions for which respective combined sensor systems are provided, such as having a trackpad and a keypad that correspond to a portion of the device surface and/or utilize separate sensor systems. One or more sensors of the array may correspond to indications of controls disposed on the surface 302 as noted previously. A particular control may map to one or multiple sensors. A groups of sensors may also map to a corresponding group of controls. Additionally, the size and spacing of sensors may be configured in a variety of ways.

The array 502 of sensors for the combined sensor system 128 is configured to support gesture, presence, location, and pressure detection. To do so, pressure sensitive sensors of the pressure sensitive sensor assembly 204 are interspersed with capacitive sensors of the capacitive sensor assembly 202 as described herein and represented in the enlarged view 504 of a portion of the array 502.

In the enlarged view 504, capacitive sensors 506 of a capacitive sensor assembly 202 are represented as being arranged in the geometric pattern, namely a pattern of four capacitive sensors 506 having shaded interiors. The shaded interiors represent adhesive 414 that is disposed in gaps associated with positions of the capacitive sensors as noted previously. In particular, the adhesive 414 is placed to substantially correspond a footprint of underlying traces 410 for the capacitive sensors as shown in FIG. 4.

Pressure sensors 508 of a pressure sensitive sensor assembly 204 are also represented as being arranged in the geometric pattern, the pressure sensors being interspersed in spaces between capacitive sensors 506. Pressure sensors 508 are illustrated as having inter-digitated trace fingers that may be formed as conductors 406 in a sensor substrate 408 as noted previously. Accordingly, pressure applied to the flexible contact layer 402 above the inter-digitated trace fingers may cause the force sensitive ink 404 to contact the conductors 406 and act as a shunt to permit a flow of electricity between the inter-digitated trace fingers. Other examples are also contemplated, such as to have a portion of the trace fingers on the flexible contact layer 402 and another portion of the trace fingers on the sensor substrate 408 with the force sensitive ink being disposed between the layers having the portions.

Additionally, supporting structures 412 are illustrated as being disposed proximate to the pressure sensors 508. In particular, supporting structures 412 in the form of copper bars are depicted as being placed generally along the four sides of the pressure sensors 508 in spaces between the pressure sensors 508 and capacitive sensors 506. Naturally, different arrangements of supporting structures 412 may be employed to provide support for pre-load control when different geometric patterns are used (e.g., hexagonally placed supports for hexagonal pattern, etc.) and/or for different kinds of pressure sensors.

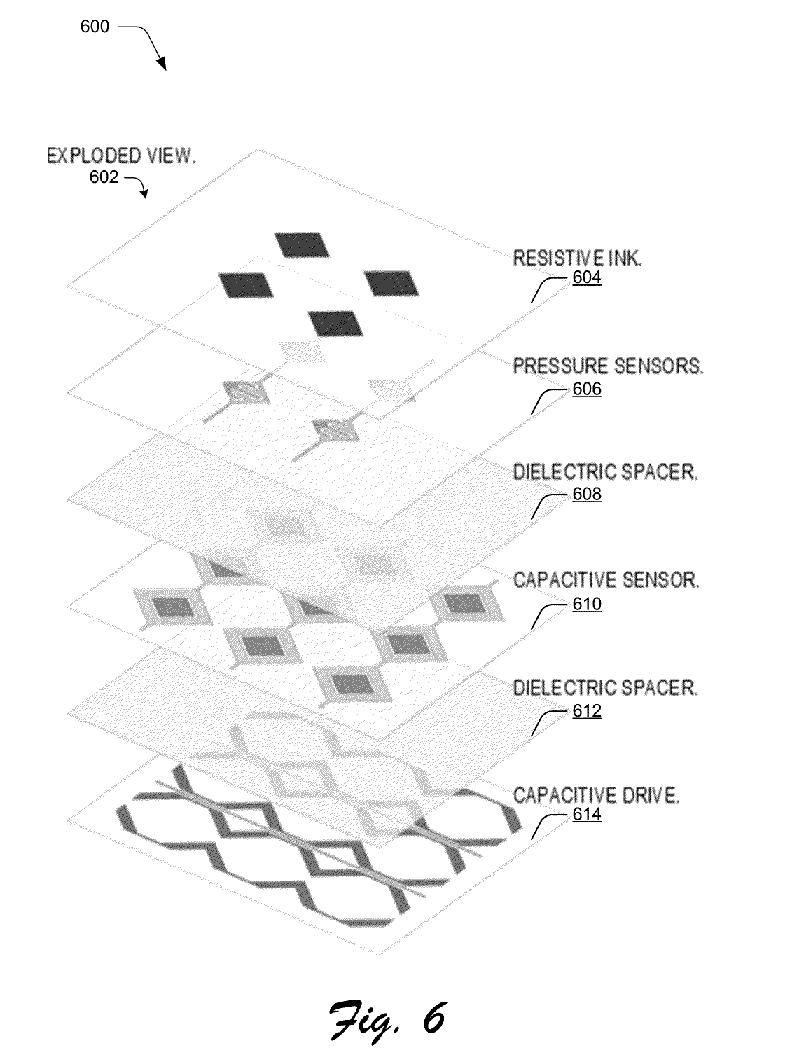

FIG. 6 depicts generally at 600 an example exploded view of a combined sensor system in which pressure sensitive sensors of a pressure sensitive sensor assembly are interspersed with capacitive sensors of a capacitive sensor assembly in accordance with one or more implementations. In particular, the exploded view shows various example layers that may be employed to construct the combined sensor system as discussed herein.

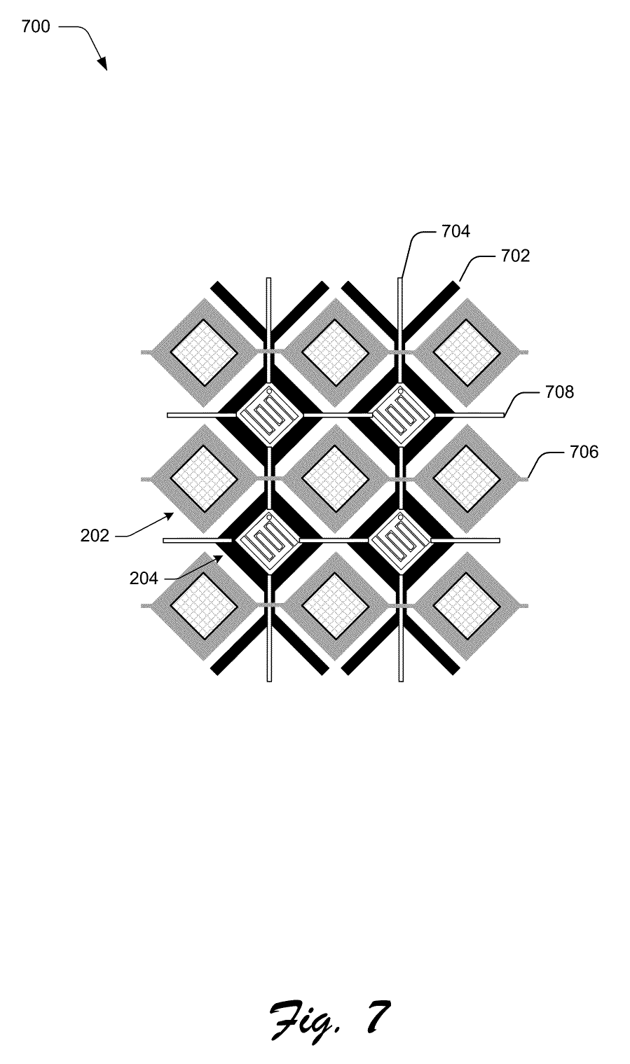

Specifically, the resistive ink 604 layer includes traces of force sensitive ink 404 that may be applied to a flexible contact layer 402 as discussed previously. The resistive ink layer 604 may be configured as a Mylar or polyester film layer. The remaining layers in the exploded view 602 represent layers and elements that may be fabricated as traces, deposits, or other components in the sensor substrate 408 to form the combined sensor system. For instance, a pressure sensors 606 layer below the resistive ink 604 layer includes conductors 406 (e.g., conductive traces in the sensor substrate 408) for pressure sensors 506 as described previously. The pressure sensors 606 layer may also include sense lines for the pressure sensors 506. A dielectric spacer layer 608 may be placed between the pressure sensors 606 layer and a capacitive sensor 610 layer that has traces 410 for the capacitive sensors 508. The capacitive sensor 610 layer may also include sense lines for the capacitive sensors 508. Another dielectric spacer layer 612 is provided between the capacitive sensor 610 layer and a capacitive drive 614 layer that contains drives lines for the capacitive sensors 508. In one or more implementations, the capacitive drive 614 layer also includes drives lines for the pressure sensors 506 as described in greater detail in relation to the discussion of FIG. 7 that follows. The example layers in the example of FIG. 6 are stacked and joined together to form the combined sensor system 128 as represented in the preceding examples of FIGS. 2 to 5.

FIG. 7 depicts generally at 700 an example layout showing details of components of a sensor substrate (e.g., PCB) for a combined sensor system in accordance with one or more implementations. The arrangement includes a layout of control lines that enables isolation of signals for the capacitive sensor assembly and the pressure sensitive sensor assembly to minimize or eliminate interference between pressure detection and capacitive sensing. In particular, the example layout of FIG. 7 shows a portion of an arrangement of a capacitive sensor assembly 202 in conjunction with a pressure sensitive sensor assembly 204 that illustrates interspersing of the assemblies as well as details regarding positioning of drive lines and sense lines (e.g., control lines) for control of a corresponding combined sensor system 128. In the depicted example, capacitive drive lines 702 are shown in black. The capacitive drive lines 702 correspond to traces that are shown in the capacitive drive 614 layer of FIG. 6. Notice that in the exploded view of FIG. 6 center portions of the low-impedance drive-side of the capacitance sensors are open in the capacitive drive 614 layer. The opening corresponds to the footprint of the pressure sensors 508 disposed within the pressure sensors 606 layer. Thus, when the layers are joined in a stack, the capacitive drive lines are configured route around the positions of the pressure sensors 508 and thereby enable nesting of the pressure sensors 508 within the openings as represented in FIG. 7.

The capctive drive lines are therefore design to go around positions of the pressure sensors 508, which minimizes interference between the combined assemblies. Additionally, the pressure sensor drive lines 704 may be disposed parallel with and inboard of capacitive drive lines 702. For example the pressure sensor drive lines 704 in FIG. 7 are depicted as being routed parallel to the capacitive drive lines 702 within the openings, gaps, or channels formed between capacitive drive lines 702. Thus, the capacitive drive lines 702 and pressure sensor drive lines 704 may be co-located in one of the layers, such as being disposed within the capacitive drive 614 layer of FIG. 6.

Capacitive sense lines 706 and pressure sense lines 708 may be contained in the pressure sensors 606 layer and capacitive sensor 610 layer respectively. The capacitive sense lines may also be open on the interior (as shown in FIG. 6), which increases sensitivity by reducing overall capacitance. This additionally equalizes conductive area between the sense and drive lines, which makes self-capacitance measurements more efficient. The adhesive 414 that is disposed for stabilization of capacitive sensing may be placed in regions corresponding to the open interiors of the capacitive sense lines 706 in the same layer or in a layer above the traces. As noted, dielectric spacer material may be employed between layers to further isolate components in the different layers. Capacitive sense lines 706 and pressure sense lines 708 may run parallel to one another, perpendicular to the drive lines, in different respective layers and/or in different coordinate positions within the array or grid. For example, capacitive sense lines 706 and pressure sense lines 708 depicted in FIG. 7 are routed laterally across the sensor grid in different alternating “rows.”

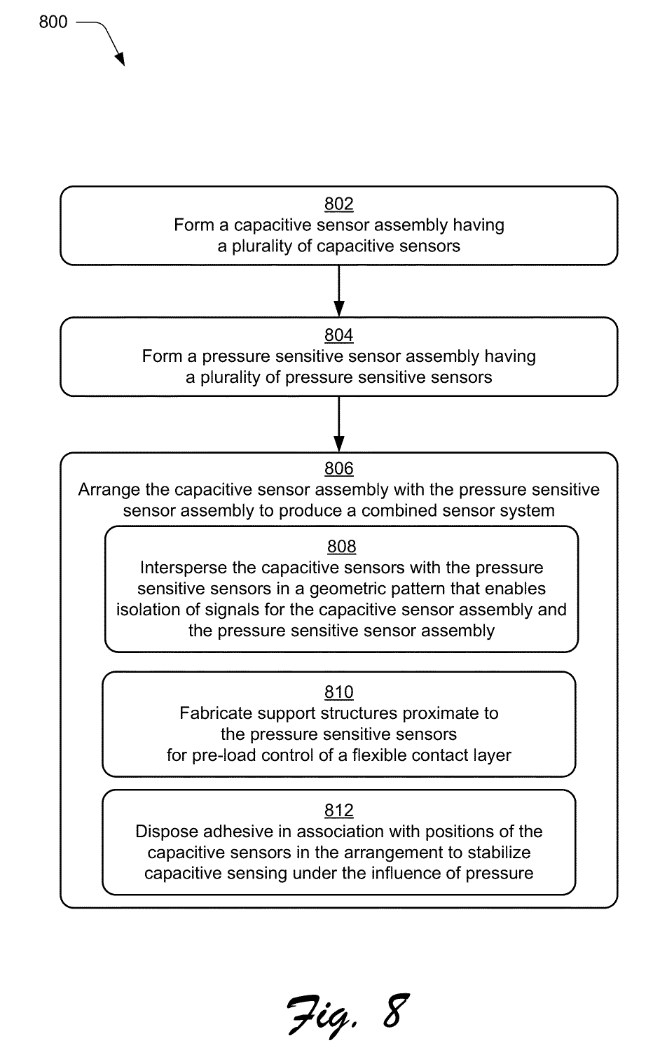

FIG. 8 depicts an example procedure 800 in which a capacitive sensor assembly and pressure sensitive sensor assembly are arranged to produce a combined sensor system in accordance with one or more embodiments. The procedure is represented as a set of blocks that specify operations performed by one or more entities and are not necessarily limited to the orders shown for performing the operations by the respective blocks. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples in this description. A capacitive sensor assembly is formed having a plurality of capacitive sensors (block 802). A pressure sensitive sensor assembly is formed having a plurality of pressure sensitive sensors (block 804). The assemblies may be formed in accordance with various examples and techniques described in this document. For example, capacitive sensors and pressure sensitive sensors may be formed in a stack of layers as represented and discussed in relation to FIGS. 2 to 4.

The capacitive sensor assembly is arranged with the pressure sensitive sensor assembly to produce a combined sensor system (block 806). As part of arranging the assemblies, the capacitive sensors are interspersed within the pressure sensitive sensors in a geometric pattern that enables isolation of signals for the capacitive sensor assembly and the pressure sensitive sensor assembly (block 808). For example, the assemblies may be arranged in a combined grid, array, and/or geometric pattern as represented and discussed in relation to FIGS. 5 to 7. Additionally, the arranging includes fabrication of support structures proximate to the pressure sensitive sensors for pre-load control of a flexible contact layer (block 808). For instance, copper bars or other suitable support structures 412 may be fabricated in a sensor substrate 408 as discussed previously herein. In one approach, the support structures are formed along with conductors 406 (e.g., FSR electrodes) in a conductive layer of a PCB assembly. Further, adhesive is disposed in association with positions of the capacitive sensors in the arrangement to stabilize capacitive sensing under the influence of pressure (block 810). For example, adhesive 414 may be placed in regions that are aligned in-line vertically with traces for capacitive sensors within layer of PCB stack as noted previously in this document.

Having considered example details and procedures for combined sensor systems, consider a discussion of an example system in accordance with one or more implementations.

Example System and Device

FIG. 9 illustrates an example system generally at 900 that includes an example computing device 902 that is representative of one or more computing systems and/or devices that may implement the various techniques described herein. The computing device 902 may be, for example, be configured to assume a mobile configuration through use of a housing formed and size to be grasped and carried by one or more hands of a user, illustrated examples of which include a mobile phone, mobile game and music device, and tablet computer although other examples are also contemplated. The input device 914 may also be configured to incorporate a combined sensor system 128 that combines a capacitive sensor assembly 202 and a pressure sensitive sensor assembly 204 as previously described.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways to support user interaction.

The computing device 902 is further illustrated as being communicatively and physically coupled to an input device 914 that is physically and communicatively removable from the computing device 902. In this way, a variety of different input devices may be coupled to the computing device 902 having a wide variety of configurations to support a wide variety of functionality. In this example, the input device 914 includes one or more controls 916 that employ a combined sensor system 128. The controls may be configured as pressure sensitive elements, buttons, a trackpad mechanically switched keys, and so forth.

The input device 914 is further illustrated as include one or more modules 918 that may be configured to support a variety of functionality. The one or more modules 918, for instance, may be configured to process analog and/or digital signals received from the controls 916 to recognize inputs and gesture, determine whether an input is indicative of resting pressure, initiate communication with a computing device, support authentication of the input device 914 for operation with the computing device 902, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

### EXAMPLE IMPLEMENTATIONS

Example implementations of combined sensor systems described herein include, but are not limited to, one or any combinations of one or more of the following examples:

### Example 1

An input device comprising: a flexible contact layer and a sensor substrate spaced apart from the flexible contact layer; and a combined sensor system comprising: a plurality of capacitive sensors formed as traces arranged in an array in the sensor substrate; a plurality of pressure sensitive sensors interspersed in the array with the plurality of capacitive sensors, the pressure sensitive sensors comprising force sensitive ink portions in the flexible contact layer configured to contact one or more conductors formed in the sensor substrate to initiate input; supporting structures fabricated proximate to each of the plurality of pressure sensitive sensors to control a pre-load level of the force sensitive ink portions with the one or more conductors; and adhesive disposed in association with positions of the plurality of capacitive sensors to stabilize capacitive sensing when pressure is applied to the combined sensor system.

### Example 2

An input device as described in any one or more of the examples in this section, wherein the one or more conductors are configured as force sensitive resistors that each include first and second inter-digitized trace fingers of conductive material.

### Example 3

An input device as described in any one or more of the examples in this section, wherein the supporting structures are fabricated along with the one or more conductors in the sensor substrate such that the supporting structures have substantially a same height as the one or more conductors.

### Example 4

An input device as described in any one or more of the examples in this section, wherein the supporting structures are configured as copper bars formed in the sensor substrate in areas between the plurality of pressure sensitive sensors and the plurality of capacitive sensors arranged in the array.

### Example 5

An input device as described in any one or more of the examples in this section, wherein the adhesive is disposed in regions between the flexible contact layer and sensor substrate that are aligned with traces for plurality of capacitive sensors in a layer stack for the combined sensor system.

### Example 6

An input device as described in any one or more of the examples in this section, wherein the array comprises a diamond pattern.

### Example 7

An input device as described in any one or more of the examples in this section, wherein the plurality of pressure sensitive sensors are interspersed with the plurality of capacitive sensors in a geometric pattern that enables isolation of signals for pressure detection and capacitive sensing.

### Example 8

An input device as described in any one or more of the examples in this section, further comprising capacitive drive lines for the plurality of capacitive sensors configured with open center portions corresponding to footprints of the plurality of the pressure sensitive sensors, such that the plurality of the pressure sensitive sensors are nested within the open center portions and the capacitive drive lines route around positions of the plurality of the pressure sensitive sensors.

### Example 9

An input device as described in any one or more of the examples in this section, further comprising pressure drive lines for the plurality of pressure sensitive sensors routed parallel to and in board of the capacitive drive lines through the open center portions.

### Example 10

An input device as described in any one or more of the examples in this section, wherein the plurality of capacitive sensors are configured to detect presence and locations of objects against or near to a surface of a device by measuring changes in capacitance due to positioning of the objects.

### Example 11

A combined sensor system for an input device comprising: a capacitive sensor assembly comprising a plurality of capacitive sensors arranged in an array configured to detect a location of an object proximate to a respective capacitive sensor of the capacitive sensor assembly; a pressure sensitive sensor comprising a plurality of pressure sensitive sensors that are configured to detect an amount of pressure applied against a respective pressure sensitive sensor of the pressure sensitive sensor assembly, the plurality of pressure sensitive sensors interspersed in the capacitive sensor array in a geometric pattern that enables isolation of signals for the capacitive sensor assembly and the pressure sensitive sensor assembly.

### Example 12

A combined sensor system as described in any one or more of the examples in this section, wherein the combined sensor system is formed in a stack of layers for a printed circuit board (PCB) assembly including a least a flexible contact layer and a sensor substrate spaced apart from the flexible contact layer.

### Example 13

A combined sensor system as described in any one or more of the examples in this section, further comprising a control line layout including capacitive drive lines for the plurality of capacitive sensors configured with open center portions and pressure drive lines for the plurality of pressure sensitive sensors routed parallel to and in board of the capacitive drive lines through the open center portions.

### Example 14

A combined sensor system as described any one or more of the examples in this section, wherein the capacitive sensor assembly comprises adhesive disposed in open spaces associated with positions of the plurality of capacitive sensors to stabilize capacitive sensing when pressure is applied to the combined sensor system.

### Example 15

A combined sensor system as described in any one or more of the examples in this section, wherein the pressure sensitive sensor assembly comprises supporting structures fabricated proximate to each of the plurality of pressure sensitive sensors to control a pre-load level of the force sensitive ink portions with the one or more conductors;

### Example 16

An apparatus comprising; one or more controls operable to initiate inputs to a computing device; a combined sensor system to detect the inputs responsive to interaction with the one or more controls, the combined sensor system formed as a stack of layers and comprising: a plurality of capacitive sensors formed as traces arranged in the stack of layers; a plurality of pressure sensitive sensors interspersed with the plurality of capacitive sensors in a geometric pattern that enables isolation of signals for pressure detection and capacitive sensing, the pressure sensitive sensors comprising force sensitive ink portions configured to contact one or more conductors formed in the stack of layers; and a control line layout comprising capacitive drive lines for the plurality of capacitive sensors configured with open center portions and pressure drive lines for the plurality of pressure sensitive sensors routed parallel to and in board of the capacitive drive lines through the open center portions.

### Example 17

The apparatus as described in any one or more of the examples in this section, wherein the combined sensor system further comprises: supporting structures fabricated proximate to each of the plurality of pressure sensitive sensors to control a pre-load level of the force sensitive ink portions with the one or more conductors; adhesive disposed in gaps associated with positions of the plurality of capacitive sensors to stabilize capacitive sensing when pressure is applied to the combined sensor system.

### Example 18

The apparatus as described in any one or more of the examples in this section, wherein the pre-load level is configured to place the force sensitive ink in constant contact with the one or more conductors to support detection of applied pressure at low-levels by the plurality of pressure sensitive sensors.

### Example 19

An apparatus as described in any one or more of the examples in this section, wherein the apparatus comprises an input device integrated with the computing device.

### Example 20

An apparatus as described in any one or more of the examples in this section, wherein the one or more controls comprise at least one of an arrangement of keys, a button, a touchpad, a trackpad, a touch sensitive bezel, or a touchscreen.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. An input device comprising:
a flexible contact layer and a sensor substrate spaced apart from the flexible contact layer; and
a combined sensor system comprising:
a plurality of capacitive sensors formed as traces arranged in an array in the sensor substrate;
a plurality of pressure sensitive sensors interspersed in the array with the plurality of capacitive sensors, the pressure sensitive sensors comprising force sensitive ink portions in the flexible contact layer configured to contact one or more conductors formed in the sensor substrate to initiate input;
supporting structures fabricated proximate to each of the plurality of pressure sensitive sensors to control a pre-load level of the force sensitive ink portions with the one or more conductors; and
adhesive disposed in association with positions of the plurality of capacitive sensors to stabilize capacitive sensing when pressure is applied to the combined sensor system.

2. An input device as described in claim 1, wherein the one or more conductors are configured as force sensitive resistors that each include first and second inter-digitized trace fingers of conductive material.

3. An input device as described in claim 1, wherein the supporting structures are fabricated along with the one or more conductors in the sensor substrate such that the supporting structures have substantially a same height as the one or more conductors.

4. An input device as described in claim 1, wherein the supporting structures are configured as copper bars formed in the sensor substrate in areas between the plurality of pressure sensitive sensors and the plurality of capacitive sensors arranged in the array.

5. An input device as described in claim 1, wherein the adhesive is disposed in regions between the flexible contact layer and sensor substrate that are aligned with traces for plurality of capacitive sensors in a layer stack for the combined sensor system.

6. An input device as described in claim 1, wherein the array comprises a diamond pattern.

7. An input device as described in claim 1, wherein the plurality of pressure sensitive sensors are interspersed with the plurality of capacitive sensors in a geometric pattern that enables isolation of signals for pressure detection and capacitive sensing.

8. An input device as described in claim 1, further comprising capacitive drive lines for the plurality of capacitive sensors configured with open center portions corresponding to footprints of the plurality of the pressure sensitive sensors, such that the plurality of the pressure sensitive sensors are nested within the open center portions and the capacitive drive lines route around positions of the plurality of the pressure sensitive sensors.

9. An input device as described in claim 8, further comprising pressure drive lines for the plurality of pressure sensitive sensors routed parallel to and in board of the capacitive drive lines through the open center portions.

10. An input device as described in claim 1, wherein the plurality of capacitive sensors are configured to detect presence and locations of objects against or near to a surface of a device by measuring changes in capacitance due to positioning of the objects.

11. A combined sensor system for an input device comprising:
a capacitive sensor assembly comprising a plurality of capacitive sensors arranged in an array configured to detect a location of an object proximate to a respective capacitive sensor of the capacitive sensor assembly;
a pressure sensitive sensor comprising a plurality of pressure sensitive sensors that are configured to detect an amount of pressure applied against a respective pressure sensitive sensor of the pressure sensitive sensor assembly, the plurality of pressure sensitive sensors interspersed in the capacitive sensor array in a geometric pattern that enables isolation of signals for the capacitive sensor assembly and the pressure sensitive sensor assembly.

12. A combined sensor system as described in claim 11, wherein the combined sensor system is formed in a stack of layers for a printed circuit board (PCB) assembly including a least a flexible contact layer and a sensor substrate spaced apart from the flexible contact layer.

13. A combined sensor system as described in claim 12, further comprising a control line layout including capacitive drive lines for the plurality of capacitive sensors configured with open center portions and pressure drive lines for the plurality of pressure sensitive sensors routed parallel to and in board of the capacitive drive lines through the open center portions.

14. A combined sensor system as described in claim 11, wherein the capacitive sensor assembly comprises adhesive disposed in open spaces associated with positions of the plurality of capacitive sensors to stabilize capacitive sensing when pressure is applied to the combined sensor system.

15. A combined sensor system as described in claim 11, wherein the pressure sensitive sensor assembly comprises supporting structures fabricated proximate to each of the plurality of pressure sensitive sensors to control a pre-load level of the force sensitive ink portions with the one or more conductors;

16. An apparatus comprising;
one or more controls operable to initiate inputs to a computing device;
a combined sensor system to detect the inputs responsive to interaction with the one or more controls, the combined sensor system formed as a stack of layers and comprising:
a plurality of capacitive sensors formed as traces arranged in the stack of layers;
a plurality of pressure sensitive sensors interspersed with the plurality of capacitive sensors in a geometric pattern that enables isolation of signals for pressure detection and capacitive sensing, the pressure sensitive sensors comprising force sensitive ink portions configured to contact one or more conductors formed in the stack of layers; and
a control line layout comprising capacitive drive lines for the plurality of capacitive sensors configured with open center portions and pressure drive lines for the plurality of pressure sensitive sensors routed parallel to and in board of the capacitive drive lines through the open center portions.

17. The apparatus as described in claim 16, wherein the combined sensor system further comprises:
supporting structures fabricated proximate to each of the plurality of pressure sensitive sensors to control a pre-load level of the force sensitive ink portions with the one or more conductors;
adhesive disposed in gaps associated with positions of the plurality of capacitive sensors to stabilize capacitive sensing when pressure is applied to the combined sensor system.

18. The apparatus as described in claim 17, wherein the pre-load level is configured to place the force sensitive ink in constant contact with the one or more conductors to support detection of applied pressure at low-levels by the plurality of pressure sensitive sensors.

19. An apparatus as described in claim 16, wherein the apparatus comprises an input device integrated with the computing device.

20. An apparatus as described in claim 16, wherein the one or more controls comprise at least one of an arrangement of keys, a button, a touchpad, a trackpad, a touch sensitive bezel, or a touchscreen.
